(19) United States
(12) Patent Application Publication
(10) Pub. No.: US 2012/0294341 A1
(43) Pub. Date: Nov. 22, 2012

(54) HYBRID CIRCUIT FOR VERY-HIGH-SPEED DIGITAL SUBSCRIBER LINE

(75) Inventors: HSIANG-SHENG WEN, Pingzhen City (TW); CHING-FENG HSIEH, Taipei City (TW)

(73) Assignee: ASKEY COMPUTER CORP.

(21) Appl. No.: 13/170,317

(22) Filed: Jun. 28, 2011

(30) Foreign Application Priority Data
May 18, 2011 (TW) 100117313

(51) Int. Cl. H04B 1/38

(52) U.S. Cl. 375/222

(57) ABSTRACT

A hybrid circuit for a Very-High-Speed Digital Subscriber Line (VDSL) blocks noise and includes a transceiving unit, a voltage transformation module, a direct current (DC) blocking capacitor, a receiving unit, and a transmitting unit. The voltage transformation module blocks noise generated as a result of transmission of an upstream signal and a downstream signal at the transceiving unit, and includes a first voltage transformation unit and a second voltage transformation unit. The DC blocking capacitor is series-connected between primary coils of the first and second voltage transformation units for preventing the direct current in the VDSL from affecting the transmission of the upstream signal and the downstream signal. Accordingly, the hybrid circuit simplifies the circuit design of the VDSL, cuts costs incurred by electronic components, and reduces the area required for circuit layout.

### CROSS-REFERENCE TO RELATED APPLICATION

This non-provisional application claims priority under 35 U.S.C. §119(a) on Patent Application No(s). 1.0011731.3 filed in Taiwan, R.O.C. on May 18, 2011, the entire contents of which are hereby incorporated by reference.

### FIELD OF TECHNOLOGY

The present invention relates to hybrid circuits, and more particularly, to a hybrid circuit for use in a Very-High-Bitrate DSL for blocking the noise generated as a result of the transmitting and sending of an upstream signal and a downstream signal by a chip interface circuit.

### BACKGROUND

Considering the ubiquity of networks and users' bandwidth needs, it is feasible to increase data transmission speeds greatly by using a Very-High-Speed Digital Subscriber Line (VDSL) of DSL specifications which are more advanced than are disclosed in prior art. VDSL has a maximum transmission speed of 50 Mb/s and thus surpasses Asymmetric Digital Subscriber Lines (ADSL) by a large margin. VDSL comprises a mixing unit, a digital signal processing unit, a digital-to-analog front-end unit, a linear driver unit, and a hybrid circuit. The mixing unit further comprises a transceiving unit and a voltage transformation unit. The quantity of the transceiving units and the voltage transformation units is a factor in the determination of the quantity of channels required for data transmission carried out by VDSL.

It is impossible for a large VDSL to use just a single channel in transmitting upstream/downstream signals; instead, a large VDSL usually uses a plurality of channels in transmitting upstream/downstream signals. However, in the face of a limited space available for a circuit board layout, the transceiving unit simplifies a circuit layout and reduces the circuit board area occupied by the circuit. Hence, the transceiving unit is of vital importance to VDSL.

Referring to FIG. 4, there is shown a schematic view of a conventional layout of a hybrid circuit for a Very-High-Speed Digital Subscriber Line (VDSL). The embodiment shown in FIG. 4 is exemplified by a 4-channel (CH1-CH4) VDSL, wherein a printed circuit board 18′ comprises four hybrid circuits 2′ and a chip interface circuit 6. The hybrid circuits 2′ each comprise a transceiving unit 8, a voltage transformation module 10, direct current (DC) blocking capacitors 12′, a receiving unit 14, and a transmitting unit 16. Regarding a conventional design, in each of the hybrid circuits 2′, the transceiving unit 8 is series-connected between two said DC blocking capacitors 12′, and thus the quantity of the DC blocking capacitors 12′ affects the area of the required circuit layout on the printed circuit board 18′.

Accordingly, it is imperative to improve a drawback of the prior art, that is, a known failure to reduce circuit layout space efficiently.

### SUMMARY

It is an objective of the present invention to provide a hybrid circuit for a Very-High-Speed Digital Subscriber Line (VDSL) with a view to cutting manufacturing costs and reducing the required circuit layout area.

In order to achieve the above and other objectives, the present invention provides a hybrid circuit for blocking noise generated as a result of transmitting and sending an upstream signal and a downstream signal by a chip interface circuit of a Very-High-Speed Digital Subscriber Line (VDSL). The hybrid circuit comprises a transceiving unit, a voltage transformation module, a direct current (DC) blocking capacitor, a receiving unit, and a transmitting unit. The transceiving unit comprises two transmission ends for transmitting the upstream signal and the downstream signal. The voltage transformation module comprises a first voltage transformation unit and a second voltage transformation unit, the first voltage transformation unit and the second voltage transformation unit each comprising a primary coil and a secondary coil, the primary coils and the secondary coils each comprising two connection terminals, wherein one of the connection terminals of each of the primary coils is connected to a corresponding one of the transmission ends of the transceiving unit. The direct current (DC) blocking capacitor is series-connected between another one of the connection terminals of the primary coil of the first voltage transformation unit and another one of the connection terminals of the primary coil of the second voltage transformation unit. The receiving unit is connected to the connection terminals of the secondary coils of the first voltage transformation unit and the second voltage transformation unit for transmitting the upstream signal. The transmitting unit is connected to the connection terminals of the secondary coils of the first voltage transformation unit and the second voltage transformation unit for transmitting the downstream signal.

In an embodiment, the DC blocking capacitor comes in a dual in-line package, and the DC blocking capacitor is of a capacitance of 27 nf.

As disclosed in the present invention, the hybrid circuit for a Very-High-Speed Digital Subscriber Line (VDSL) enables the DC blocking capacitor to be series-connected between a plurality of primary coils of a voltage transformation module.

Compared with the prior art, the present invention provides a hybrid circuit for a Very-High-Speed Digital Subscriber Line (VDSL) to not only enable simplified circuit layout design and thereby overcome drawbacks of the prior art—a complicated circuit design causes difficulty and complexity in circuit layout design, and the resultant increase in circuit fabrication costs but also reduce the required occupied area on a printed circuit board.

### BRIEF DESCRIPTION OF THE DRAWINGS

Objectives, features, and advantages of the present invention are hereunder illustrated with specific embodiments in conjunction with the accompanying drawings, in which:

FIG. 1 is a block diagram of a hybrid circuit for a Very-High-Speed Digital Subscriber Line (VDSL) according to the first embodiment of the present invention;

FIG. 2 is a schematic view of a layout of a hybrid circuit for a Very-High-Speed Digital Subscriber Line (VDSL) according to the first embodiment of the present invention;

FIG. 3 is a block diagram of a hybrid circuit for a Very-High-Speed Digital Subscriber Line (VDSL) according to the second embodiment of the present invention; and

FIG. 4 (PRIOR ART) is a schematic view of a conventional layout of a hybrid circuit for a Very-High-Speed Digital Subscriber Line (VDSL).

### DETAILED DESCRIPTION

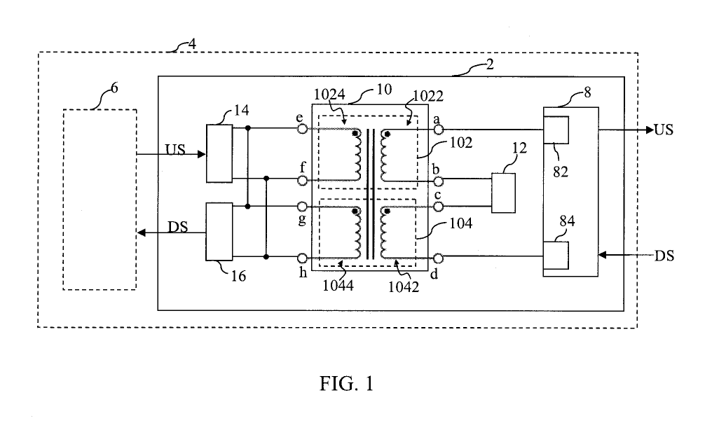

Referring to FIG. 1, there is shown a block diagram of a hybrid circuit for a Very-High-Speed Digital Subscriber Line (VDSL) according to the first embodiment of the present invention. As shown in FIG. 1, a hybrid circuit 2 in a Very-High-Speed Digital Subscriber Line (VDSL) 4 blocks the noise that originates from a chip interface circuit 6 (such as a digital-to-analog conversion interface or an analog front-end circuit), such that an upstream signal US and a downstream signal DS are free from noise interference and therefore can be correctly transmitted.

The hybrid circuit 2 comprises a transceiving unit 8, a voltage transformation module 10, a direct current (DC) blocking capacitor 12, a receiving unit 14, and a transmitting unit 16. The transceiving unit 8 comprises two transmission ends 82, 84. The transceiving unit 8 transmits the upstream signal US and the downstream signal DS. The transceiving unit 8 receives the upstream signal US and the downstream signal DS in the analog form. As shown in FIG. 1, in an embodiment, the transmission end 82 receives the upstream signal US from the voltage transformation module 10, and the transmission end 84 receives the downstream signal DS from an external source.

The hybrid circuit 2 separates the upstream signal US of the receiving unit 14 and the downstream signal DS of the transmitting unit 16 to enable the hybrid circuit 2 of the VDSL 4 to effectuate full duplex network transmission. For example, the receiving unit 14 receives the upstream signal US from the chip interface circuit 6, and then the upstream signal US thus received is sent out of the VDSL 4 by the transceiving unit 8 of the hybrid circuit 2. The transceiving unit 8 receives the downstream signal DS from an external source, and then the downstream signal DS thus received is sent to the chip interface circuit 6 by the transmitting unit 16 of the hybrid circuit 2. The hybrid circuit 2 prevents the upstream signal US from entering the transmitting unit 16 and prevents the downstream signal DS from entering the receiving unit 14.

The voltage transformation module 10 comprises a first voltage transformation unit 102 and a second voltage transformation unit 104. The first voltage transformation unit 102 comprises a primary coil 1022 and a secondary coil 1024. The second voltage transformation unit 104 comprises a primary coil 1042 and a secondary coil 1044. The primary coils 102:2, 1042 and the secondary coils 1024, 1044 each comprise two connection terminals, namely connection terminals a, b, connection terminals c, d, connection terminals e, f, and connection terminals g, h.

As shown in FIG. 1, the connection terminal a of the primary coil 1022 is connected to the transmission end 82, and the connection terminal d of the primary coil 1042 is connected to the transmission end 84.

The DC blocking capacitor 12 is connected to the connection terminal b of the primary coil 1022 of the first voltage transformation unit 102 and connected to the connection terminal c of the primary coil 1042 of the second voltage transformation unit 104. The DC blocking capacitor 12 comes in a dual in-line package. Furthermore, in an embodiment of the present invention, the capacitance of the DC blocking capacitor 12 is preferably 27 nf. For example, the DC blocking capacitor 12 of a capacitance of 27 nf works well in conjunction with a chipset of an 8-channel VDSL of the model VINAX-M V2.

The receiving unit 14 is connected to the connection terminals e, f of the secondary coil 1024 of the first voltage transformation unit 102 and connected to the connection terminals g, h of the secondary coil 1044 of the second voltage transformation unit 104. Hence, the receiving unit 14 provides a path for transmitting the upstream signal US from the chip interface circuit 6 to the voltage transformation module 10.

The transmitting unit 16 is connected to the connection terminals e, f of the secondary coil 1024 of the first voltage transformation unit 102 and connected to the connection terminals g, h of the secondary coil 1044 of the second voltage transformation unit 104. The transmitting unit 16 provides a path for transmitting the downstream signal DS from the voltage transformation module 10 to the chip interface circuit 6.

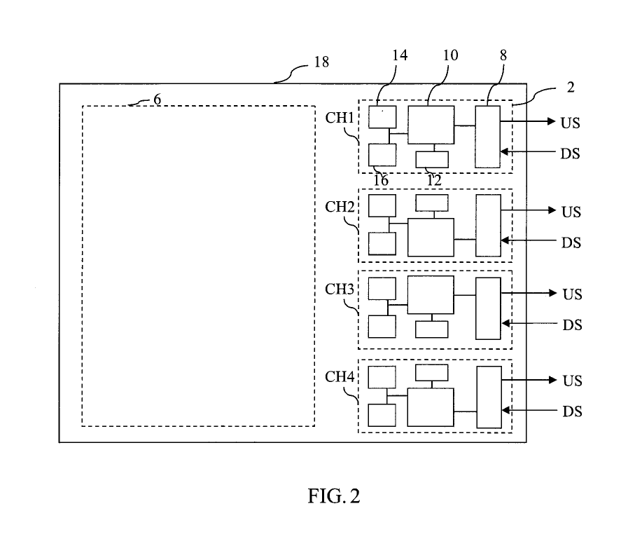

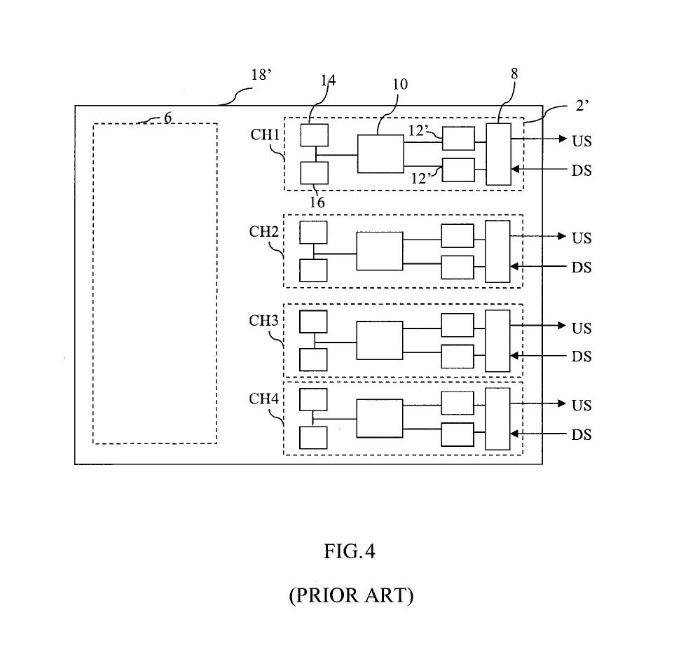

Referring to FIG. 2, there is shown a schematic view of a layout of a hybrid circuit for a Very-High-Speed Digital Subscriber Line (VDSL) according to the first embodiment of the present invention. As shown in FIG. 2, an embodiment of the present invention is exemplified by a 4-channel (CH1-CH4) VDSL. The four channels correspond in position to the hybrid circuits 2, respectively. The hybrid circuits 2 are arranged on a printed circuit board 18. The hybrid circuits 2 each comprise the transceiving unit 8, the voltage transformation module 10, the DC blocking capacitor 12, the receiving unit 14, and the transmitting unit 16. Compared with the hybrid circuit 2′ disclosed by the prior art and shown in FIG. 4, the hybrid circuits 2 in this embodiment of the present reduces the area required for a circuit layout.

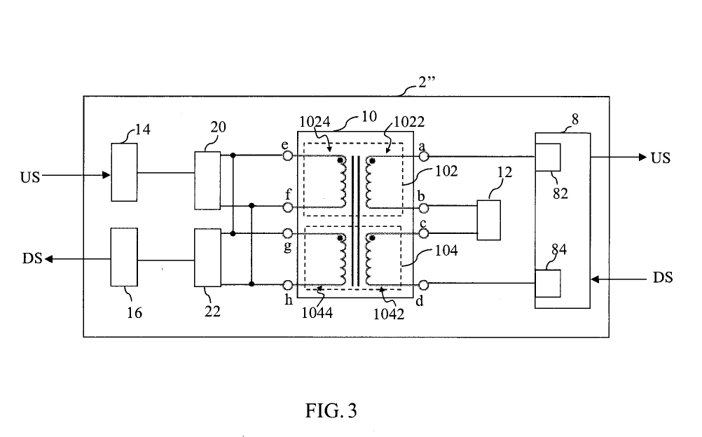

Referring to FIG. 3, there is shown a block diagram of a hybrid circuit for a Very-High-Speed Digital Subscriber Line (VDSL) according to the second embodiment of the present invention. As shown in FIG. 3, the second embodiment differs from the first embodiment in that the hybrid circuit 2″ in the second embodiment further comprises a linear driver unit 20 and a high pass filter unit 22. The linear driver unit 20 is series-connected between the receiving unit 14 and the voltage transformation module 10 for preventing the upstream signal US from deteriorating in fidelity and for maintaining the reliability of the upstream signal US. The high pass filter unit 22 is series-connected between the transmitting unit 16 and the voltage transformation module 10 for filtering out the low-frequency noise of the downstream signal DS.

A hybrid circuit for a VDSL in each of the above embodiments enables a DC blocking capacitor to be concurrently connected to a plurality of primary coils of a voltage transformation module. The DC blocking capacitor not only blocks a direct current in the VDSL, but also prevents the direct current from affecting an upstream signal or a downstream signal through the transceiving unit.

Compared with the prior art, the present invention provides a hybrid circuit for a Very-High-Speed Digital Subscriber Line (VDSL) to not only enable simplified circuit layout design and thereby overcome drawbacks of the prior art—a complicated circuit design causes difficulty and complexity in circuit layout design, and the resultant increase in circuit fabrication costs—but also reduce the required occupied area on a printed circuit board.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A hybrid circuit for a Very-High-Speed Digital Subscriber Line (VDSL), the hybrid circuit blocking noise generated as a result of transmitting and sending an upstream signal and a downstream signal by a chip interface circuit of the VDSL, the hybrid circuit comprising:
a transceiving unit comprising two transmission ends for transmitting the upstream signal and the downstream signal;
a voltage transformation module comprising a first voltage transformation unit and a second voltage transformation unit, the first voltage transformation unit and the second voltage transformation unit each comprising a primary coil and a secondary coil, the primary coils and the secondary coils each comprising two connection terminals, wherein one of the connection terminals of each of the primary coils is connected to a corresponding one of the transmission ends of the transceiving unit;
a direct current (DC) blocking capacitor series-connected between another one of the connection terminals of the primary coil of the first voltage transformation unit and another one of the connection terminals of the primary coil of the second voltage transformation unit;
a receiving unit connected to the connection terminals of the secondary coils of the first voltage transformation unit and the second voltage transformation unit for transmitting the upstream signal; and
a transmitting unit connected to the connection terminals of the secondary coils of the first voltage transformation unit and the second voltage transformation unit for transmitting the downstream signal.

2. The hybrid circuit of claim 1, wherein the DC blocking capacitor comes in a dual in-line package.

3. The hybrid circuit of claim 2, wherein the DC blocking capacitor is of a capacitance of 27 nf.

4. The hybrid circuit of claim 1, further comprising:
a linear driver unit series-connected between the receiving unit and the voltage transformation module; and
a high pass filter unit series-connected between the transmitting unit and the voltage transformation module.
